(19) United States
(12) Patent Application Publication
(10) Pub. No.: US 2026/0078958 A1
(43) Pub. Date: Mar. 19, 2026

(54) RADIANT ELEMENT POWERED BY HEATING MEANS AND USE OF IT

(71) Applicant: Massimiliano BISSON, Tezze sul Brenta (Vicenza) (IT)

(72) Inventor: Massimiliano BISSON, Tezze sul Brenta (Vicenza) (IT)

(21) Appl. No.: 19/109,918

(22) PCT Filed: Aug. 3, 2023
(86) PCT No.: PCT/IB2023/057854

§ 371 Date: Mar. 7, 2025

(30) Foreign Application Priority Data
Sep. 8, 2022 (IT) 102022000018297

(51) Int. Cl. F27D 99/00; H05B 3/64; H05B 3/66

(52) U.S. Cl. CPC F27D 99/0006; F27D 99/0033; H05B 3/64; H05B 3/66; F27D 2099/0011; F27D 2099/0045; H05B 2203/032

(57) ABSTRACT

Radiant element, usable in at least one furnace for heat treatment, and/or for continuous galvanizing and annealing lines of sheet metal strips or plates and/or other products made of steel and/or other metals and/or for the modernization of at least one pre-existing furnace, wherein the radiant element is used to emit and/or radiate heat, wherein the radiant element has a main longitudinal extension (L) and a transversal extension (M), perpendicular to the main longitudinal extension (L), and includes a shaped wall which defines an external surface, an internal surface and an internal cavity, in addition to at least two main hollow seats, adapted in use to house at least one heating means and at least one connection seat; radiant system and use of this radiant element.

### TECHNICAL FIELD OF THE INVENTION

The present invention relates to a radiant element powered electrically or in general by means of a heating means, for industrial plants and the like, which can be used in the sector of furnaces or plants for the heat treatment of steel and/or other metals.

More specifically, the present invention relates to a radiant element powered and/or heated electrically or in general by means of a heating means which can be used in furnaces for heat treatment in general, and/or continuous galvanizing and continuous annealing lines (CGL, AGL, CAPL or CAL lines, etc.) of strips or panels made of sheet metal, bolts, wire rods, pipes, components for pipes and for fittings, treatment and production of “Advanced High Strength Steel” (AHSS) and new steel grades and/or other products made of steel and/or other metals.

Furthermore, the radiant element according to the present invention can be used both for new continuous galvanizing and continuous annealing lines and for the revamping of old furnaces of continuous galvanizing and continuous annealing lines, and in any furnace for heat treatment in general.

The present invention therefore finds application both in the automotive sector and in the steel and/or aluminium sector, etc.

### TECHNICAL BACKGROUND

The increasingly devastating climate changes, with the consequent need to reduce NOx and CO2 emissions into the atmosphere, have forced industries in general—and steel producers in particular—to undertake worldwide a series of substantial actions to achieve this goal in a short time.

As is known, most ferrous materials or aluminium alloys and other materials, suitable for the production of components necessary for daily life, are subjected to heat treatments to obtain better durability, greater hardness and/or performance longer over time during their functional cycle.

In this sense, in the steel/automotive branch and in general, heating furnaces are used which are used to carry out heat treatments at high temperatures (from 200° C. up to over 1200° C.) on the materials which are then sold and used in many types of industry.

The heat treatment, for example of sheet metal and its derivatives, today is mostly carried out through the heating deriving from radiant tubes of any shape (W or M, U, Double P and Single P, I, L or any other geometric shape), so that the sheet metal that passes, in the form of a continuous band, near them, can undergo the desired heat treatment.

The materials used to make these radiant tubes have characteristics of high resistance to temperatures up to 1200° C. and above (in the case of radiant tubes made of ceramic material, a thermal resistance of up to 1500° C. is obtained).

These tubes are usually connected to a gas burner (or other fuels such as hydrogen, methane or other are also used) which generates the temperature and power necessary for their operation and for the treatment to be carried out.

These systems require a flame entry area (burner side), a smoke passage area (to heat the radiant tube) and a smoke outlet area with recovery unit (for the reduction of the very high emissions inside the tubes themselves and for the possible recirculation of part of the fumes so that they can be re-combusted thus lowering the final emissions).

These burners release a very hot flame (up to and beyond 1300° C.) inside the radiant tubes, which by radiation (hence the name radiant tube) heat the strip, for example of metal sheet that passes inside the furnace until the required treatment is reached to obtain each single and specific “Grade” according to the future operating characteristics of the various products to which the strip itself will be applied.

All these fuel systems currently in use cause a very high level of emissions into the atmosphere, especially NOx and CO2.

For example, if the European Community has set an emission range per line (furnace) from 100 mg/m³ to 300 mg/m³, and each individual European state can decide the minimum and maximum allowed, there are many plants in Europe, in the USA and in all other parts of the world in which the aforementioned values are abundantly exceeded, even reaching levels of 350 mg/m³ up to 500 mg/m³ and beyond.

Many efforts have been made so that these emission levels could be reduced but although the efforts made by all companies in the sector have been very important, due to the system itself (burner, gas, fume recirculation systems inside the pipes radiant, recuperative, etc.) it is increasingly difficult to obtain satisfactory and long-lasting results.

In fact, one of the problems of flame burners is precisely maintaining the combustion parameters over time so that there is a constant and contained emission. The “unraveling” (loss) of the parameters (tuning) of use involves continuous requests for maintenance and control otherwise, as in almost all cases, there is a quick return to the basic conditions which lead to an increase in the emission parameters (too high according to current regulations) over time, Inconveniences of this type oblige steel producers to invest a lot of money in the control and continuous regulation (“tuning”) of burners and combustion systems. Furthermore, this loss of the basic parameters of optimum combustion often leads to a greater aggressiveness of the burner flame, leading to serious life problems for the radiant tubes with deformations on the hottest parts (generally on the burner side), cracks on the materials themselves and welds, and a continuous need for spare parts and line stops (furnaces) for the replacement of damaged pieces.

There are also furnaces provided with a plurality of heating elements of the electric type, in which the heating elements operate preferably at a high kilowatt value, to keep both their number and their size to a minimum, as well as the size of the furnace itself. Usually, the heating elements operate inside a tubular container, which protects the heating elements themselves from the gases present inside the furnace.

However, these heating elements must operate at high power and high watt density (calculated as the value in watts per square centimetre of the surface area of the conductive element), in order to supply the furnace with the power necessary for the work being done at its internal, and this causes a high risk of short circuit or system failure.

Not even increasing the number of heating elements solves the problem, because this requires that the size of the furnace is increased, with consequent increases in any losses and related operating costs, not to mention the fact that existing furnaces are often not equipped to support such an increase.

U.S. Pat. No. 5,473,141 discloses a heating assembly used inside radiators for electric furnaces. The heating elements of the heating assembly are shaped like a shaped rod and mounted on ceramic insulating discs which support the rod elements themselves. There may be a single tube cover to protect the heating elements.

U.S. Pat. No. 5,083,012 discloses a single tube heating element for a furnace comprising a wire resistance where this resistance comprises a plurality of wires connected in parallel so as to provide a high wattage while maintaining the watt density below a safety threshold.

It can therefore be seen that there is a strong need to provide a radiant element powered electrically or in general by means of a heating means which is capable of overcoming the drawbacks of the prior art mentioned above.

### SUMMARY OF THE INVENTION

The technical task of the present invention is therefore that of improving the state of the prior art.

Within the scope of this technical aim, an object of the present invention is to provide a radiant element which allows to reduce or eliminate emissions, for example NOx and CO2, caused by heat treatment lines in any sector, from the automotive to the steel, to that of aluminium, etc.

A further object of the present invention is to provide a radiant element which allows a reduction in the aggressiveness of heat with respect to that created by known systems with burner, while maintaining an excellent thermal radiation and/or thermal transmission capacity.

A still further object of a version of the present invention is to provide a radiant clement which, in the heat treatment sector, no longer requires burners powered by any fuel, but is powered in an alternative way, for example electrically, for example by electrically powered means of/with electrical induction.

A further object of the present invention is to provide a radiant element capable of guaranteeing improved thermal efficiency and a uniform temperature (if desired by increasing it) along the entire surface of the radiant element itself.

A still further object of the present invention is to provide a radiant element capable of lasting longer and having a longer life than traditional radiant tubes since-guaranteeing uniformity of temperature along its entire extension-it has the possibility to undergo the same expansion and return movement in the change of temperatures necessary for the heat treatment of the materials, effectively reducing the stress and cracks or tears to which the material constituting the radiant element itself can be subjected.

This aim and object are achieved by the radiant element according to the present application.

Further advantageous characteristics are described in the present application.

### BRIEF DESCRIPTION OF THE DRAWINGS

The characteristics of the invention will be better understood by any person skilled in the art from the following description and from the annexed tables of drawings, given as a non-limiting example, in which:

FIG. 1 is a side view of one version of a radiant element according to the present invention,

FIG. 2 is a rear view of the radiant element of FIG. 1,

FIG. 3 is a perspective view of one version of the radiant element according to the present invention,

FIG. 4A is a side view of another version of the radiant element according to the present invention,

FIG. 4B is a sectional view taken along the plane of trace C-C of FIG. 4A,

FIG. 4C is a front view of a part of the radiant element of FIG. 4A, in which the support of the radiant clement itself can be seen,

FIG. 4D is a rear view of the radiant element of FIG. 4A,

FIGS. 5A and 5B respectively illustrate two resistors or electric resistances, respectively with electric wires and with electric plates,

FIGS. 6A and 6B illustrate respectively a side view of a version of the radiant element according to the present invention and a sectional view taken along the plane of trace D-D of FIG. 6A,

FIGS. 7A and 7B illustrate respectively a side view of a version of the radiant element according to the present invention and a sectional view taken along the plane of trace D-D of FIG. 7A, and

FIGS. 8A and 8B show two perspective views of a further version of the radiant element according to the present invention.

### DETAILED DESCRIPTION

With reference to the attached figures, 1 indicates a radiant element, which can be used in furnaces for heat treatment, and/or for continuous galvanizing and annealing lines of strips or plates of sheet metal and/or other products made of steel and/or in other metals, in particular the CGL, AGL, CAPL or CAL lines, etc., and/or for the modernization of pre-existing furnaces.

The present invention also refers to a complete radiant system, and therefore to a radiant and heating system, of which the radiant element 1 is a part, together with at least one heating means 10, such as for example at least one electric or fuel powered heating means. The at least one heating means, for example electric or fuel-powered, is a heating means for the radiant element 1. It is in fact capable of heating the radiant element, for example up to a temperature of over 1200° C., and allowing the latter to emit/radiate the heat outwards (for example towards the sheet metal strip which passes in its proximity for the desired heat treatment) to carry out the heat treatment itself.

This at least one heating means 10, in its electrically powered version, comprises or is in the form of at least one electrical resistance (for example also called resistor).

The at least one electrically powered heating means 10 can be electrically inductive or have at least one electrically induction.

In an alternative version, the heating means 10 is fuel-powered, i.e. it is a burner powered, for example, by gas, hydrogen, methane, biofuel, zero-emission fuel, e-fuel, carbon neutral synthetic fuel, etc.

In at least one version of the present invention, as better specified below, the radiant element contains and houses at least one heating means 10.

The use of electrical resistances is common for heating, for example, homes or working environments (offices and large sheds). In this case, however, the powers of use and above all the temperatures to be obtained are very low because their purpose is to heat the rooms for normal daily life.

In the field of treatment of materials in general (steel, aluminium, copper, etc.), however, as indicated above, very high powers are required and above all extremely high temperatures (up to 1200° C. and above if necessary).

Therefore, the at least one heating means according to the present invention must be able to ensure the power and the achievement of the necessary temperature for the operation outlined above.

The electrical resistances, due to their weight, their conformation and the materials of which they are made, present a different thermal expansion compared to that which occurs for the material of which it is made or with which the radiant element 1 is made.

In fact, the radiant element according to the present invention can be obtained from a metal sheet with or without a high or low nickel, molybdenum or cobalt alloy, such as for example Inconel 600/601/602, Avesta, Alloy 800H, AISI 309/310/316/321, Kanthal APM/APM-T, Al, or from at least one material obtained by fusion/casting, forging, extrusion or other or any other material usable for the purpose.

The radiant element according to the present invention has a completely innovative shape and design.

This also in relation to the fact that, being in at least one of its versions released and independent of a burner for its heating, it no longer requires one or more entry zones for the fumes and/or flame deriving from the burner, nor one or more fumes exit zones. Despite this, the radiant element according to the present invention is an element capable of determining thermal radiation/irradiation and of obtaining all the required advantages in terms of energy efficiency, heat transmission and reduction or elimination of harmful emissions, in particular for example of NOx and CO2.

In particular, the radiant element 1 has a substantially hollow shape having a main longitudinal extension L (or length) and a transversal extension M (or width). Furthermore, it has a thickness W.

In particular, “longitudinal” means a direction or a plane that extends along a principal and/or major direction of the radiant element 1 while “transversal” means a direction or a plane that extends along a direction perpendicular to the longitudinal direction.

The radiant element 1 comprises a shaped wall 2 which defines an external surface 3b and an internal surface 3a, as well as an internal cavity 4.

The internal surface 3a faces the internal cavity 4. The external surface 3b, opposite the internal surface 3a, faces the object to be treated in use.

The internal cavity 4 extends substantially along the entire longitudinal extension L of the radiant element 1. In particular, at least two main hollow seats 5 can be identified in the cavity 4. The main hollow seats 5 have a parallel pattern to each other and parallel to the main extension L of radiant element 1.

The cross section of each main hollow seat 5 has a circular or polygonal shape, such as for example square, rectangular, prismatic, hexagonal, octagonal, etc.

The internal cavity 4 also defines and/or comprises at least one connection seat 6, able to connect the at least two main hollow seats 5. The connection seat 6 is preferably hollow. In an alternative version, the connection seat 6 is closed or full.

The at least one connection seat 6 is arranged parallel to the at least two main hollow seats 5 and therefore also extends substantially along the longitudinal extension L of the radiant element 1.

The at least one connection seat 6 has a substantially polygonal cross-section, for example rectangular or square.

The length of the main hollow seats 5 and/or of the connection seats 6 substantially corresponds to the length of the radiant element 1.

In at least one version of the invention, the connection seat 6 is in fluid connection with the at least two main hollow seats 5. Indeed, at least in this version, the internal cavity 4 is unique and is formed by the internal hollow space of the at least two main hollow seats 5 and of the at least one connection seat 6.

Considering the transversal extension M of the radiant element 1, the at least two main hollow seats 5 and the at least one connection seat 6 are arranged on the same plane. They are therefore coplanar. The radiant element itself is coplanar, i.e. it has a substantially flat extension.

Usually, the main hollow seats 5 are placed on the outer longitudinal sides of the radiant element 1.

According to at least one version of the invention, between the main hollow seat 5 and the connection seat 6 there is at least one (internal) passage or connection port or opening 7 which puts the seats in communication, for example of fluid 5, 6.

These ports or openings 7 are arranged, according to one version of the present invention, on the same plane, for example parallel to the plane defined and/or on which the main hollow seats 5 and the connection seats 6 lie.

The ports or openings 7 are internal, in the sense that they do not involve the wall 2 of the radiant element 1.

The wall 2 of the radiant element, in fact, in at least one version of the invention, is continuous and—at least as regards the longitudinal extension L and the transversal extension M—has no openings which can put the internal cavity 4 in communication with the outside.

In an alternative embodiment, in which the connection seat 6 is closed or filled, the main hollow seats 5 are not fluid connected by the connection seat 6 and may or may not be fluid connected to each other.

The radiant element 1 also has two transverse ends 8, located on opposite sides of the longitudinal extension L of the radiant element 1.

The ends 8 are closed, in at least one version of the invention. In particular, as will be better understood from what follows, the ends 8 of the radiant element 1 are closed on one side by a containment element or pad 12 and on the other side by a closing panel 15, which will be better defined hereinafter.

At the transverse ends 8, the radiant element 1 can be connected and/or positioned in use at at least one wall or two walls of the furnace inside which the radiant element is positioned.

In particular, according to at least one version of the present invention, there is a first transversal end 8a in use positioned at a first wall of the furnace, in which there is a support called “furnace side” or “socket” 20, considering the traditional denomination of the furnaces equipped with a burner or other systems that do not require a classic flame burner with or without the presence of a fume recuperator (burner and systems which in the case of the present invention, of course, will not be present or will not be active, as the invention according to the present invention is powered differently and/or electrically).

The socket 20 traditionally consists, in at least one version, of a support fixed to this first wall of the furnace.

In particular, according to at least one version, the radiant element is equipped with a support 9 for the radiant element (placed at a first transverse end Sa of the radiant element itself, for example fixed and/or constrained to the closing panel 15) able to be supported by and/or to move on the socket 20. This socket 20 can comprise at least one portion or surface or a compartment usually able to come into contact with the support 9. The socket 20 and/or the support 9 can be made of a metal material resistant to high temperatures, such as: an austenitic steel material, a high or low nickel content (or high nickel alloyed) or molybdenum or cobalt steel material, a ceramic material, a carbide silicon material, a material that is the same as that of the radiant element 1, etc.

These materials have a thermal expansion of between 0 mm and 20 mm or greater, depending on the temperatures of use and their conformation.

The support 9 can be placed in use, for example, on the internal socket 20 of the already existing furnace.

The support 9 of the radiant element 1 has a shape and a size which depends, according to at least one version of the present invention, on the socket 20 already present in the furnace, both as regards its shape and its positioning.

In particular, the support 9 can have a conformation, which protrudes from the radiant element 1, tubular or curved or flat, considering in the latter two cases the base surface which rests on the respective surface of the socket 20 and depends on the type of socket 20 in which the radiant element 1 can be applied and/or connected.

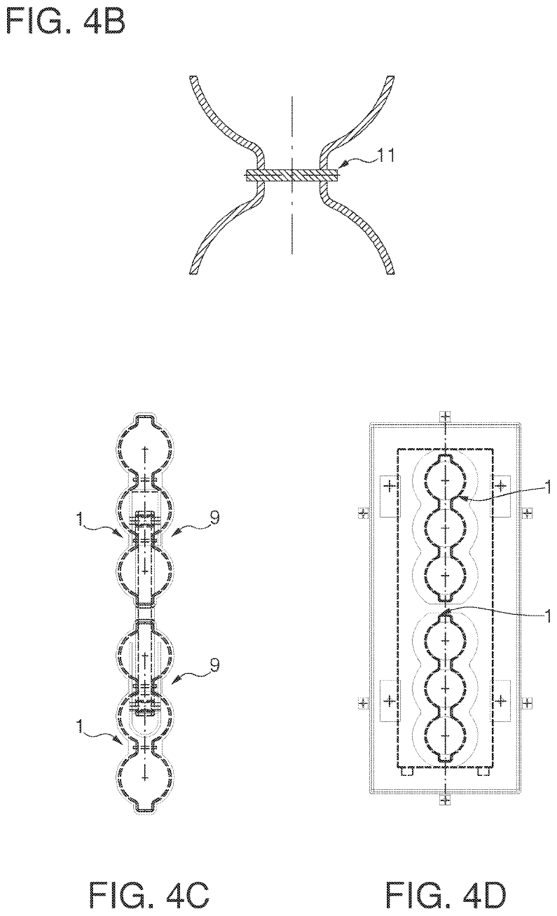

As can be seen, for example, from FIG. 4C, the support 9 can have a support base for the socket 20 having a curved shape, with the concavity moving away from the socket 20 itself. This conformation of the support 9 can also be defined as a U.

Precisely for the reason that the support 9 depends on the type of socket 20 in which it will be inserted and/or rested, the support 9 can be positioned in variable points of the first end 8a and/or can be formed by a single element or by several elements (even one for each main hollow seat 5).

Furthermore, according to at least one version of the present invention, as anticipated above, at least one closing panel 15 can be present for at least one of the ends 8 of the radiant element 1, for example located at the first end 8a of the radiant element 1. The closing panel 15 can be a portion of metal sheet (for example of the same material as the radiant element 1) having a straight or curved shape or with other shapes.

If the support 9 is present, the closing panel 15 will be able to receive and be connected to the support 9 and be able to support (or help to support) the weight of the radiant element 1 and of the at least one heating means 10 contained therein.

There is also a second transverse end 8b of the radiant element 1, which can be connected and/or positioned at a second wall of the furnace, for example a wall opposite the first wall on the furnace side (the latter being equipped with a furnace side support or socket 20). The burner was traditionally positioned in the second wall of existing furnaces, for example placed in a rear position with respect to what in the present invention is defined as a containment element or pad 12, already mentioned and better described hereinafter, The radiant element 1 according to the present invention, in fact, can also adapt and be connected to the walls of current furnaces, those usually equipped with traditional-type radiant tubes, using the hooks inside the furnaces (so-called furnace-side sockets/supports 20) already present. In this way, costs can be reduced by users in the case of revamping of entire lines, as it would only be necessary to implement these furnaces with heating means other than the traditional ones, for example with electric current emission systems needed for the operation of the electrically powered heating means 10.

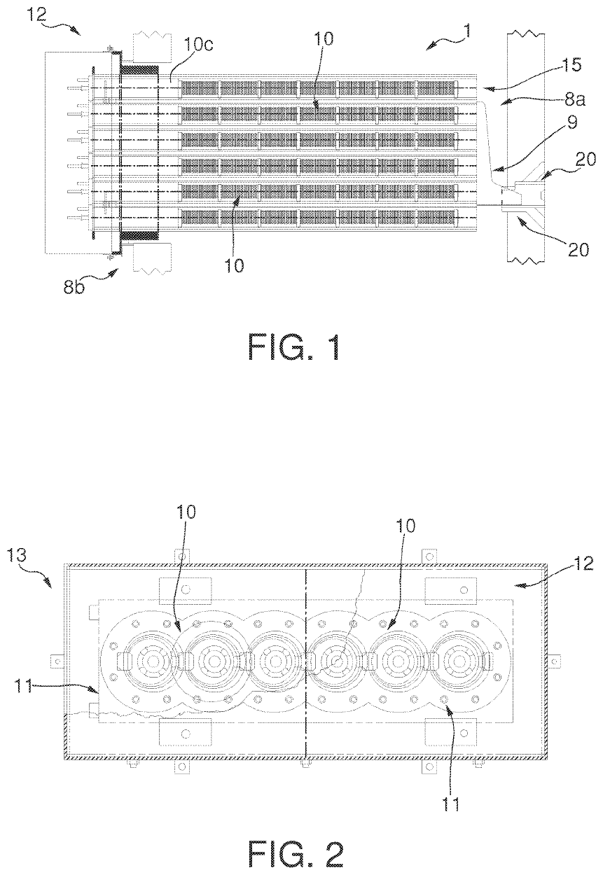

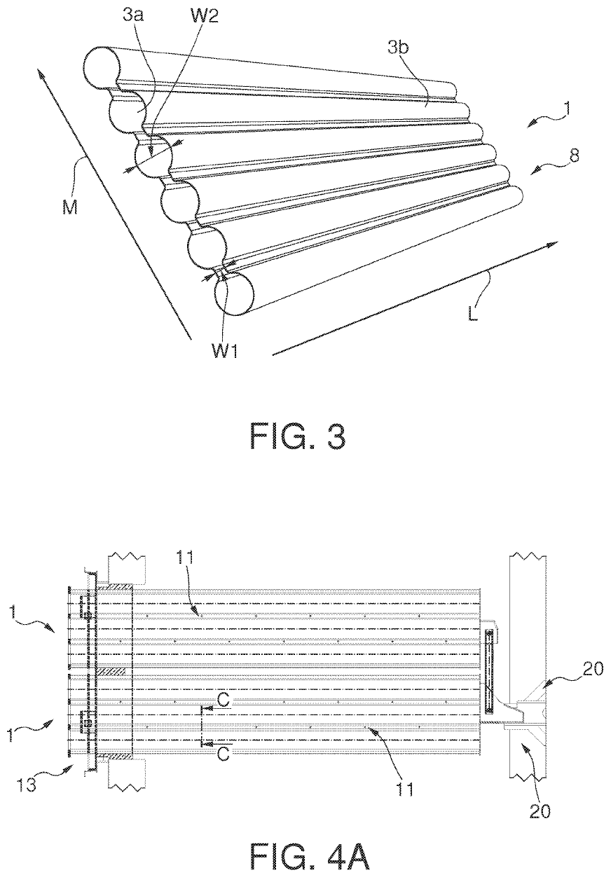

According to a version of the present invention, for example illustrated in FIGS. 1, 3, 6 A and 7A, the radiant element 1 comprises six main hollow seats 5 and five connection seats 6.

In a further version of the present invention, for example illustrated in FIGS. 4A, 8A and 8B, the radiant element 1 comprises three main hollow seats 5 and two connection seats 6.

In an even further version of the present invention, it is possible to associate in a same furnace seat (or in a same pad, as will be indicated hereinbelow) two or more radiant elements 1 (for example a first radiant clement or upper radiant element and a second radiant element or lower radiant element), each equipped with several main hollow seats 5 and one, two or more connection seats 6.

According to one version of the present invention, the upper radiant element and the lower radiant element each comprise three main hollow seats 5 and two connection seats 6, and each contains three electrical resistances.

In this way, the weight of the entire system is also distributed.

A (free) space of 5 cm or between 2 cm and 10 cm or between 1 cm and 50 cm can be maintained between the upper and lower radiant element. In this way, enough space is provided to predict the possible sagging or lowering of the upper radiant element. This can further lengthen the life of the radiant clement according to the present invention.

In this case, or also according to further variants of the present invention, it is also possible to decide to keep functioning only some of the heating means 10 present, i.e. for example those of a radiant element are functioning and the means of the other are switched off, if needed.

Furthermore, it would also be possible to position heating means of a certain size and/or power at at least one main hollow seat 5 and at least one (further) heating means of smaller size and/or power than the others installed in the same radiant element, in at least one other main hollow seat 5, for example positioned at the lowest part in use of the radiant element itself,

In this way, it would be possible to reduce the weight and/or the deformation caused by the at least one heating means 10 in those parts of the radiant element which are instead more subject to deformation due precisely to the weight and/or temperature determined by the at least a heating means 10.

Naturally, thanks to the peculiarities of the present invention, it is in any case possible to guarantee homogeneity of heating and therefore of heat treatment.

Or, the at least one radiant element 1 or the radiant elements 1, when several radiant elements 1 are associated in the same seat of the furnace (or as will be seen hereinafter in the same pad), can be equipped with less than three or more than three main hollow seats 5; the number of connection seats 6 depends on the number of main hollow seats 5. For example, according to at least one version of the present invention, if the number of main hollow seats 5 is n, with n greater than or equal to two, the number of connection seats 6 is n−1.

According to a further version of the present invention, there are two main hollow seats 5 and one connection seat 6, or four main hollow seats 5 and three connection seats 6, eight main hollow seats 5 and seven connection seats 6 and so on.

In at least one version of the present invention, the main hollow seats have a substantially cylindrical or parallelepiped shape; the connection seats 6 can have a parallelepiped shape with a polygonal, rectangular or square base.

Generally, the width, considered along the transversal direction M of the radiant element 1, of the at least one main hollow seat 5 is greater than the width of the at least one connection seat 6.

In FIGS. 8A and 8B, the width, considered along the transverse direction M of the radiant element 1, of the at least one main hollow seat 5 is smaller than the width of the at least one connection seat 6. However, this version of the invention is dedicated to the specific needs of the furnaces in which the respective radiant elements are installed.

According to at least one version of the present invention, the connection seats 6, also considering any ports or openings 7, are formed and/or delimited by two portions 6a, 6b of the wall 2, having an extension parallel to the substantially rectangular longitudinal one L and overlapping to each other.

These portions 6a, 6b are connected, if desired without interruptions and/or in one piece, with at least one part 5a or with at least two parts 5a, 5b of the wall 2 which form and/or delimit each main hollow seat 5.

According to at least one version of the present invention, the at least one part 5a or the two parts 5a, 5b has/have a concavity facing in use towards the inside of the radiant element and/or towards the internal cavity 4.

In particular, the main hollow seat 5 which is connected to a single connection seat 6 has a single part 5a, having a substantially circular or polygonal section, corresponding to the cross section of the main hollow seat 5, but it is an open section at at least one port or opening 7.

These main hollow seats 5 are the outermost ones, located at the outer longitudinal sides of the radiant element 1.

Instead, if present, the main hollow seat 5 which is connected to two connection seats 6, one by one considering the transversal extension M of the radiant element 1, is formed and/or delimited by two parts 5a, 5b, each having a circular sector section or a part of a polygon, so as to form, together, substantially the cross section of the corresponding main hollow seat 5. Similarly, there will be two ports or openings 7, to form a sort of completion, together with the parts 5a, 5b, of the cross section of the main hollow seat 5. These ports or openings 7 will be positioned on the opposite sides, considering the main hollow seat 5 and the transversal extension M of the radiant element.

Obviously, in the version in which the connection seat 6 is closed or full, the section of the main hollow seat 5 is determined both by the part 5a, 5b and by the possible internal surface that closes the connection seat 6 (together with the portion 6a, 6b), preventing the connection of fluid with the main hollow seat 5.

In particular, the portion 6a and the part 5a constitute a sort of first major or front face of the radiant element while the portion 6b and the part 5b constitute a sort of second major or rear face of the radiant element; the longitudinal sides of the radiant element 1 generally consist of at least one part 5a having a transversal conformation substantially corresponding to the transversal section of the at least one main hollow seat 5.

The thickness W of the radiant element, according to at least one version of the present invention, is not constant. In fact, the thickness can be understood for example as the distance W 1 between the portions 6a, 6b or the distance W2 between the portions 5a, 5b. Distance W2 is greater than distance W1.

The thickness W2, according to at least one version of the present invention, corresponds to the diameter of the circular section of the main hollow seat 5.

The thickness W1, according to at least one version of the present invention, corresponds to the width of the opening or port 7.

Furthermore, according to at least one version of the present invention, the wall 2 has a thickness of about 5 mm.

At least according to one version of the present invention, in fact, the connection seats 6 are ideally formed by four longitudinal sides, two of which—parallel and opposite—are formed by the portions 6a, 6b, the other two by the ports or openings 7, thus resulting-in fact-empty spaces inside the cavity 4.

According to an alternative version, the connection seats 6 are formed by four longitudinal sides, two of which—parallel and opposite—are formed by the portions 6a, 6b, the other two by the internal surfaces which—in fact—close the connection seat 6.

As regards the wall 2 of the radiant element 1, on the other hand, it is formed by a single piece of the material which constitutes the radiant element 1, for example by a shaped sheet, and constituted by the portions 6a, 6b and by the parts 5a, 5b. In particular, the wall 2 extends correspondingly to the radiant element 1 and is capable of enclosing the internal cavity 4.

The wall 2 is made in one piece, i.e. it is made by shaping (at least) a single piece of sheet metal which is joined together, for example by welding, to create the desired closed conformation for the radiant element 1.

According to an alternative version, the wall 2 is made by joining together, for example by welding, several pieces of material which constitutes the radiant element 1, for example two sorts of half-shells, one front and one rear, in order to make for the same the desired conformation.

The wall 2, as mentioned, is shaped in the sense that it has longitudinal protrusions corresponding to the main hollow seats 5 and, even more particularly, to the part 5a, 5b thereof.

The wall 2 also has portions, between one part 5a, 5b and the other, corresponding to the portions 6a, 6b substantially corresponding to the connection seats 6.

The portions 6a, 6b which constitute the connection seats 6 can be flat or slightly hollow or slightly convex or raised with respect to the cavity 4.

This shaping of the wall 2 corresponds both to the external surface 3b and to the internal surface 3 a of the wall 2.

The fact that the wall 2 is continuous and/or full, i.e. does not have holes or empty areas, allows the radiant element 1 to be more efficient.

It is possible to think, for example, about traditional radiant tubes: they are made up of straight tubes, the ends of which are joined by curved tubular elements, for the recirculation of the fumes. Furthermore, between one straight tube and another (mainly for the P, double P, U and double U conformations) there are “empty” areas, which distance the straight tubes themselves, determining the presence of “empty areas” which do not contribute to the emission and/or radiation of heat, being precisely “empty” and not made by the material that makes the tubes of the radiant tube. This causes an inefficiency of traditional radiant tubes.

The same applies to the single tubular elements, which are in any case spaced apart from each other.

Furthermore, as regards traditional radiant tubes, fed by a fuel burner, their temperature is not uniform along their longitudinal extension: in fact, there are a very hot area (burner/flame side), an area of constant temperature decreasing (fumes passage area) and a colder area (fumes exit side).

These disadvantages are not present with the radiant clement according to the present invention, which therefore results in having an increased thermal transmission (compared to traditional systems) thanks precisely to the fact that the wall 2 is continuous and “full”; moreover, in one version, thanks to the absence of the burner, and the presence instead of at least one heating means 10, a uniform temperature is obtained along the entire surface or wall 2 of the radiant element, both from one side to the other and from one transverse end 8a to the other 8b.

This advantage can also be achieved when the heating means 10 are fed with fuel since, being the same ones housed at least partially inside the main hollow seats 5, they contribute to an improved homogeneity of heating along the entire surface or wall 2 of the radiant element, both from one side to the other and from one transverse end thereof 8 a to the other 8b.

Furthermore, thanks to the difference in heating and/or power supply, it is also possible to increase the temperature that can be reached by the wall 2, thus also increasing the thermal and heat transmission efficiency of the radiant element 1 according to the present invention towards the ribbon (strip).

In at least one version of the present invention, the heating means 10 is not a burner. Furthermore, thanks to these advantages, there is also a lengthening of the life of the radiant element 1, since the material of which it is built and composed has the possibility of undergoing the same expansion and return movement in the change of temperatures necessary for the treatment thermal, reducing the possibility of tears (cracks) and stress on the material itself. Of course, by reducing these risk factors for the integrity of the radiant element, a longer life is determined.

Again, the expedients indicated above for the present invention make it possible to reduce power and heating consumption. In fact, by increasing the heat exchange surface (compared to traditional type radiant tubes) less energy is required (lower temperature) to obtain the same result in terms of heat emission. Furthermore, having a uniformity of temperature for the entire surface of the radiant element, a better uniformity and quality of heat treatment of the strip or metal sheet is obtained, also capable of allowing the development of new Steel Grades for the markets of each type.

The radiant element 1 comprises and houses, as indicated above, at least one heating means 10, for example electrically or fuel-powered, to form the system of the present invention. This at least one heating means 10 is housed in the at least one main hollow seat 5. In particular, each main hollow seat 5 can contain at least one means 10.

The at least one heating means 10 is removable, in the sense that it can also be replaced individually in the event of default or failure to operate.

Furthermore, the presence of the means 10 allows easier control of the heat treatments since, in the specific version, the electric current is constant in its use unlike combustion burner systems which—as previously specified—require continuous control of the tuning and of the emissions deriving from the imbalances also created by various gases and fuels on the market, leading to a significant reduction in management costs compared to the current ones.

As anticipated, these new radiant elements make it possible to reduce and/or eliminate harmful emissions, for example of NOx and CO2, at the same time reducing the risks for the environment and those for operators who have to view the furnaces and/or carry out maintenance on them, precisely because the atmosphere inside them—devoid of these harmful substances—causes a lower risk of intoxication due to the inhalation of toxic gases and fumes.

The fact that the at least one means 10 is contained inside the at least one main hollow seat 5 allows—with a single element such as the radiant element 1—to concentrate all the technology necessary for its heating and for the obtaining maximum performance in terms of energy/heat transmission, temperature uniformity and lengthening of the life of the radiant element itself.

The shape of the at least one main hollow seat depends on the shape and/or power of the at least one means 10, for example of the at least one electrical resistance or of the fuel burner.

To determine which and how many means 10 are to be positioned inside the radiant element, in fact, it is necessary to take into consideration which temperature level must be reached for the specific heat treatment to be performed.

The radiant element 1 according to the present invention, in order to be able to house the at least one heating means 10 inside it, also comprises at least one reinforcing means 11, preferably positioned inside the at least one main hollow seat 5 and/or inside a connection seat 6. The purpose of this reinforcing means 11 is to assist the support and/or fixing in position of at least one means 10.

The reinforcing means 11 comprises at least one plate, screw, bolt, rod, pin, peg or other similar reinforcing member; they can be fixed, welded or press-fitted on the internal surface 3a and/or on the external surface 3b of the radiant element 1 and/or on at least one of the portions 6a, 6b of the at least one connection seat 6 and/or or of the part 5a, 5b of the at least one main hollow seat 5. The reinforcing means 11 are preferably internal or mostly internal.

The at least one reinforcing means 11 can have a cylindrical, conical, flat, parallelepiped, prismatic, etc. shape.

According to a particular version of the invention, the at least one reinforcing means 11 is positioned (internally) at the portion 6a and/or the portion 6b of the at least one connection seat 6. In this way, it is possible to reduce the effects of blow-up (swelling) of the radiant element itself as well as the effects of sagging and distortion of the material of which it is composed.

According to at least one version of the present invention, the reinforcing means 11 are a plurality or series and are positioned, spaced apart from each other, along the entire longitudinal extension of the radiant element 1, preferably at the connection seats 6, or at least one of them. Such reinforcing means are for example illustrated in detail in FIG. 4B. As can be seen from this exemplary image, according to one version of the present invention, the reinforcing means 11 are shaped like a pin, the ends of which are fixed to each portion 6a, 6b of the connection seats 6.

As can be seen for example in FIG. 6A, the reinforcing means 11 can be in the form of plates I 1a, arranged along the longitudinal direction of the radiant element 1. Furthermore, as can be seen from this exemplary figure, said reinforcing means 11a in the form of a plate are positioned at at least one connection seat 6, preferably in a low or lower position, considering the radiant element 1 installed in use.

The number, length and arrangement of the reinforcement means 11a can vary according to the needs of the reinforcement itself.

The means 11a, of course, can allow the communication of fluid inside the cavity 4 and therefore can be provided with slots or other openings to allow the passage of air or other gases contained inside the radiant element 1 and therefore ensure uniformity of heat transmission,

In at least one version of the present invention, the reinforcing means 11 comprise both pins and/or pegs and plates 11a.

In fact, the weight of at least one means 10, for example of the respective electrical resistances or of the fuel burner, can constitute a problem for the radiant element I according to the present invention since the material used for the radiant element itself, at the high temperatures, may lose its ability to support weights. Therefore, if called upon to support an excessive weight, the radiant element 1 could undergo deformation and/or damage.

According to at least one version of the present invention, the area most subject to deformation, due to the high temperatures and/or the weight of the heating means 10, is located below (considering the radiant element 1 installed in use) and/or located at the first end 8a.

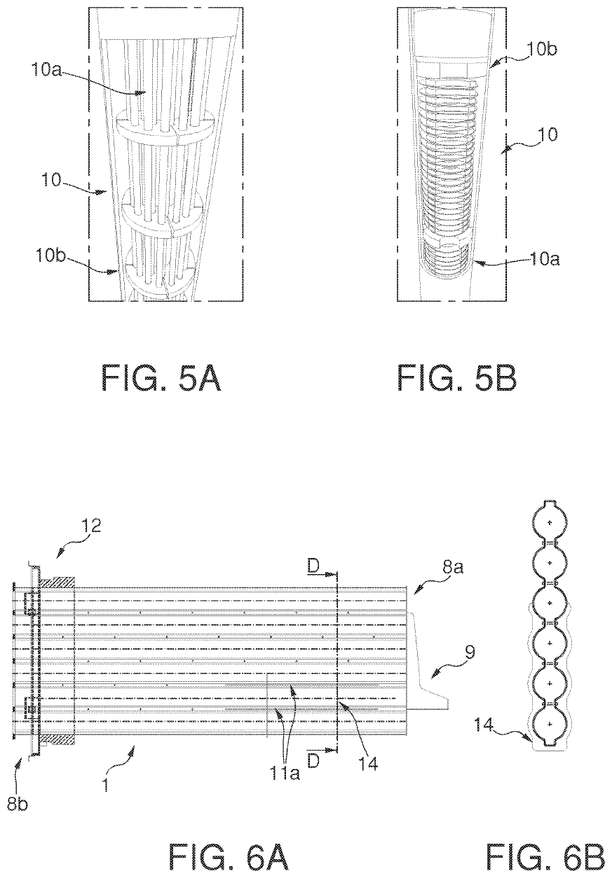

According to one version of the invention, the means 10, for example the electrical resistance, comprises a plurality of longitudinal wires or electrical plates 10a (placed next to each other) inside which electric current passes (as can be seen, for example, in FIGS. 5A and 5B).

This plurality of wires or plates is kept in position and supported by at least one disc or by at least one plate 10b. This disc or plate 10b has at its central portion at least one hole for the passage of the electric wires 10a (FIG. 5 A), which (as also happens for the electric plates) must not touch each other and/or must not touch the material which is placed in their proximity, such as for example the internal surface of the radiant element 1 (to reduce the risk of short circuit).

This disc or plate 10b therefore has an external portion 10c, if desired in the shape of a ring, which separates the electric wires or plates 10a from the surrounding environment.

According to at least one version of the present invention, the disc or plate 10b and/or its external portion 10c rests on the internal surface 3 a of the radiant element, present at the at least one main hollow seat 5. Therefore, in fact it rests on the internal surface 3a at the parts 5a, 5b of the at least one main hollow seat 5.

This disc or plate 10b is made of a refractory material such as for example a ceramic material or the like.

In the version in which, on the other hand, the heating means 10 comprise a fuel burner, they in turn have discs or plates, or other suitable means, which have a portion, if desired external, which can rest on the internal surface 3a at the parts 5a, 5b of the at least one main hollow seat 5 or in another suitable seat of the radiant element 1 or of at least one wall of the furnace. Alternatively, the heating means 10 in the form of a fuel burner can be fixed at at least one of the transverse ends 8 of the radiant element, so as to be fixed in position without touching the internal surface 3a.

Therefore, the at least one reinforcing means 11, 1 la supports and distributes the weight of the means 10 where necessary, for example along the longitudinal extension L of the element itself. Specifically, in fact, according to at least one version of the present invention, the at least one means 10 is not in contact with the at least one reinforcing means 11, 11a. The latter, in fact, being for example placed in series along the extension of the at least one connection seat 6, keep fixed the distance between the portions 6a, 6b, preventing the radiant element from opening or increasing its thickness W, at least in some parts thereof, causing a consequent displacement of the at least one means 10 contained therein.

In this way, thanks to the presence of the at least one reinforcing means 11, 11a, the breaking of the discs or plates 10b of the means 10 is reduced, the deformation of the radiant element 1 is reduced and the sliding of the discs or plates 10b with respect to the radiant element 1 itself.

By “sliding” we mean the expansion movement, for example by elongation, caused by the high operating temperatures to which the materials are subjected during the treatment (since parts of different materials also have different elongations at high temperatures). Naturally, ensuring a lower default of the components involved, a thermal efficiency is guaranteed over time.

The at least one reinforcing means 11, 11a can be a separate element, positioned at the internal surface 3a of the radiant element, or it can be part of the radiant element 1 itself, in the sense that it can be obtained by bending and special conformation of the metal sheet with which it is made.

Naturally, the number and arrangement of the electric wires or the number and section of the electric plates (which can have a circular section or present any shape and shape) or the shape and size of the fuel burner varies the shape and size of the discs or plates 10b and consequently also of the at least one reinforcing means 11, 11a.

The at least one heating means, when in the form of electrically powered means 10, can have different shapes and conformations and the radiant element 1—or rather the at least two main hollow seats 5—will adapt to them or vice versa.

The electric current supply cables can emerge from the at least one heating means 10. These cables are directed, for example, towards the second end 8b of the radiant element 1. Therefore, the latter only needs an area (for example located at the second end 8b) for the entry and/or exit of the supply cables of the at least one means 10.

In particular, these cables are placed at the pad 12 and/or stop outside the pad 12. The same applies when the at least one heating means 10 is in the form of a fuel burner.

The means 10, with an internal end if desired, substantially reach a few centimetres from the closure panel 15 located at the first end 8a of the radiant element 1.

As mentioned, each main hollow seat 5 can house one, two, three, four, five, six or more means 10 inside it, on the basis of its dimensions and the power required for its heating. The radiant element 1 also comprises, at the second end 8b (or exit end), a containment element 12 previously mentioned. The containment element 12 is at the rear with respect to the radiant element 1. It is composed of a box-like element, preferably made of metal, which is known in the jargon as a “pad”. It is resistant to high temperatures and has a protection system for the external side and/or the external area. This protection system can comprise fiber inside, a covering or cladding shaped for example like a stainless-steel plate towards the internal wall of the furnace and in iron towards the external wall of the furnace itself. If desired, such protection system can comprise a material constituted by or based on biological fiber and/or ceramic material able to avoid the heat transmission outside the radiant element 1 and/or the furnace in which it is installed.

The containment element 12 is therefore placed outside the furnace and the radiant elements are positioned thereon, for example at their second end 8b.

The containment element 12 and/or the protection system can also comprise a covering element, if desired made of metal sheet, for example to cover the electric cables of the means 10 to protect the operators of the furnaces to avoid short circuits or accidental damage.

The pad is therefore thermally isolated.

Furthermore, the positioning of at least one means 10 with respect to the pad also acts as a protection for those working in the field. In fact, the at least one means 10 reaches very low temperatures in its initial section (facing the second end 8b of the radiant element), ensuring a heat emission towards the outside of the furnace (work area for the operators) lower than the 85° C.

This was certainly not possible with traditional radiant tube systems, while the external temperature parameter is also regulated by stringent standards on the matter. The present invention, thanks to the aforesaid contrivance, also manages to comply with these requirements.

The hermetic closure on the outside of the furnace and of the heating system can take place by means of one or more series of flanges or a single flange 13 shaped, for example on the basis of the number of means 10 to be inserted. This at least one flange is located on the rear side of the radiant element 1, i.e. at its second end 8b.

It is possible to have a flange 13 for each means 10 or a flange 13 for some or all means 10. According to at least one version of the invention, the at least one flange 13 is placed only at the pad 12 and/or at the second end 8b and/or can be used to fix the respective means 10, for example by means of screws and bolts.

In this way, the replacement times of the electrical resistances and/or of the at least one means 10 are reduced and greater safety is obtained for the operator when called upon to replace such at least one means 10.

Furthermore, in at least one version of the present invention, the at least one flange 13 may include at least one external compensator. The at least one external compensator has the function of allowing any requests for expansion of the radiant element 1 also towards the outside of the furnace itself (they are possible expansions of approximately +/−5 cm).

According to at least one version of the present invention, the shape of the radiant element 1 can be different considering the internal surface 3a and the external surface 3b. This is because the radiant element 1 can comprise reinforcing and/or stiffening means such as longitudinal, transversal and/or horizontal corrugations, studs of any shape and size, ribs, grooves or other.

These reinforcing and/or stiffening means can be positioned and/or made at the internal surface 3a and/or the external surface 3b of the radiant element 1.

These reinforcing and/or stiffening means can be obtained directly from the shaping of the metal sheet which makes up the radiant element 1, for example by calendering or pressing with suitable molds or by successive applications of welding or other known fixing systems.

These reinforcing and/or stiffening means can serve to stiffen the material of the radiant element 1 and, consequently, guarantee a longer life thereof.

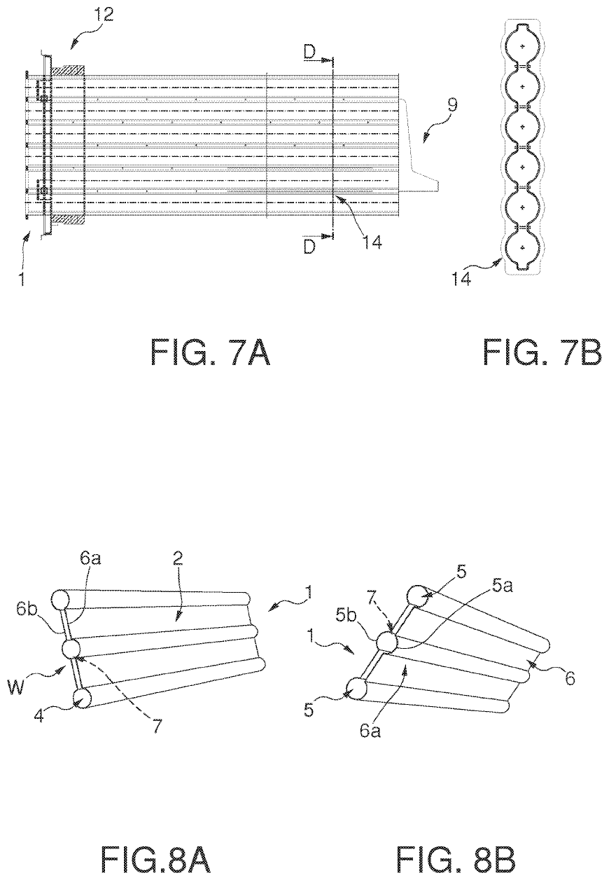

FIGS. 6B and 7B show two examples of reinforcing and/or stiffening means, i.e. respectively a reinforcing and/or stiffening means 14, of the external type, which covers only part of the outer surface of the radiant element 1 (FIG. 6B, in particular it is placed at the three or four main hollow seats 5 starting from the bottom in use, therefore has a sort of U-shape which embraces starting from the bottom and at least partially both the front face and the rear face of the element radiant element 1) or the entire external surface of the radiant element (FIG. 7B, in which the reinforcing and/or stiffening means 14 embraces the entire perimeter of the radiant element, considering its transversal extension M, both as regards the front face than the rear one of the radiant element I). The reinforcing and/or stiffening means 14 can be made of material resistant to high temperatures, for example selected from the possible materials for the radiant element 1, such as for example a material with or without a high or low alloy or high or alloyed with Nickel or molybdenum or cobalt, such as for example Inconel 600/601/602, Avesta, Alloy 800H, AISI 309/310/316/321, Kanthal APM/APM-T, Al, or in at least one material obtained by fusion/casting, forging, extrusion or other or any other material usable for the purpose, such as, for example, Inconel 600/601/602, Avesta, Alloy 800H, AISI 309/310/316/321, Kanthal APM/APM-T, Al, or in at least one material obtained by melting/casting, forging, extrusion or other or any other material usable for the purpose.

The reinforcing and/or stiffening means 14 can have an extension in length equal to the main longitudinal extension L of the radiant element 1 or they can be placed only on part of the same, for example in a central position and/or at the end 8a, 8b of the same (preferably 8a) or still in the points of the radiant element 1 in which several yields related to the temperature and/or to the weight of the at least one means 10 that the radiant element contains can occur,

The reinforcing and/or stiffening means 14 have the purpose of reinforcing the structure of the radiant element 1, for example at at least one of its ends 8, to reduce or avoid torsions or deformations of any kind of the entire structure or of part of it. In at least one version of the present invention, the means 14 are positioned at the external surface 3b of the wall 2 of the radiant element 1.

In the version in which the radiant element 1 is positioned in the furnace with a horizontal arrangement (considering that, unless explicitly clear to the contrary, the positions indicated above generally refer to a positioning of the radiant element in the furnace with a vertical arrangement or valid both with a vertical and horizontal arrangement) the reinforcing and/or stiffening means and/or the at least one reinforcing means 11, 11a are positioned at the in use upper (or facing the ceiling) and/or rear (or facing the ground) face of the radiant element 1. In this case, the reinforcing and/or stiffening means and/or the at least one reinforcing means 11, 11a can be in the form of plates, ribs or longitudinal grooves, corrugations, bosses, protrusions and/or fixed, etc., protruding internally and/or externally, placed for example at the external and/or internal surface of the at least one main seat 5, and/or facing upwards and/or downwards, shapes of the material which constitutes the element radiant element or elements welded in correspondence with it, having a length corresponding to that of the radiant element considering its longitudinal extension, or in segments, with a constant or irregular pitch according to the specific areas that need greater stiffening and/or reinforcement, etc.

The radiant element 1 can be formed and/or shaped by pressing the metal sheet, calendering at least part of the radiant element 1 and/or it can be obtained by melting, centrifugation of the at least one metal that composes it, forging and/or modelling, etc. Thanks to the specific shape and/or the manufacturing method of the radiant element according to the present invention, it has a very small number of cuts in the material that composes it and, consequently, of parts welded together.

Consider, for example, a radiant tube of the traditional type, for example of the W type, consisting for example of four straight tubes with longitudinal welding, three curved tubular portions molded in two halves with internal and external welding, four or more circumferential welding for the union of the various elements. The radiant element according to at least one version of the present invention, on the other hand, can comprise a single longitudinal weld, for example to join the two longitudinal edges of a sheet duly cut to size and shaped, in order to join the wall 2 and determine the formation of the internal cavity 4.

The radiant element 1 according to the present invention, in at least one version of the present invention, can consist of at least one shaped sheet (so as to form the parts 5a, 5b and the portions 6a, 6b) or of two or more shaped sheets, depending on the shape of the radiant element 1 and/or the type of furnace (longitudinal, vertical, etc.) in which it is to be installed (for example in the case of installation inside an existing furnace).

The wall 2 of the radiant element 1, therefore, in at least one version of the present invention, consists of and/or forms at least one shell or two or more half-shells installed in the same containment element 12 (pad).

When the connection seats 6 are internally hollow, they constitute a sort of empty space inside the internal cavity 4. This allows the passage of heat between one means 10 and another and between one main hollow seat and another. In this way, the temperature is uniformed along the whole surface of the radiant element 1 and this guarantees also a homogeneous dilatation and expansion of the material, reducing stress and fatigue on the radiant element, significantly prolonging its life.

Furthermore, the presence of the connection seats 6 has the function of supporting the means 10 and allowing it to expand due to the increase in temperature. The connection seats 6, in fact, having as mentioned a thickness W1 less than the thickness W2 of the main hollow seats 5, form a sort of narrowing inside the cavity 4 and the discs or plates 10b of the electrical or fuel powered heating means 10 and/or the at least one reinforcing means 11, rest on this narrowing.

The width (taken considering the transversal direction of the radiant element 1) of the portions 6a, 6b can be a few centimetres or between 1 cm and 5 cm or between 1 cm and 25 cm.

As specified above, in any case the whole wall 2 of the radiant element 1 heats up, including the portions 6a, 6b, and therefore temperature uniformity and improved heat transmission thermal efficiency are guaranteed.

It has thus been seen how the invention achieves the intended aims.

The radiant element 1 according to the present invention, in fact, has a uniform temperature along its entire extension and has a mass or radiating surface increased for example by more than 65% compared to the radiating tubes currently on the market.

For example, the W-shaped radiant tube has a total surface area of 5.6 m² with a maximum exchange surface of 3.7 m² while the radiant element 1 according to the present invention has a total surface area of 7.7 m² with an exchange surface of at least 6.1 m² (for the same length, considering the same furnace). Obviously, these values change from furnace to furnace, as each furnace has different distances between the walls but the surface advantage remains in proportion to the wall to wall (i.e. the distance from wall to wall). This allows the following advantages:
A. Reduction of consumption: for example a gas burner has an average/maximum efficiency of 75-80% while that of the heating means, for example, with electric supply 10, is 90-100%. Therefore, if you wanted to replace a burner with a power of 150 Kw, resistances with powers up to a maximum of 110/120 Kw would be enough, obtaining the same heating result (naturally the powers can be even higher, even up to 200 Kw and beyond, depending on the needs);
B. Management of the radiant element: it is possible to adjust its use according to the real heat treatment needs of the strip since the radiant mass (or surface) and the at least one heating means have the possibility of supporting all needs, being highly performing;
C. Improving the quality of the heat treatment and therefore of the passing ribbon: this is obtained thanks to the uniformity of radiation and heat emission obtained thanks to the radiant element according to the present invention, with the possibility of increasing and improving the technical and mechanical characteristics of the ribbon for ever more extreme uses in the industry to which it will then be applied (for example in the automotive and/or aerospace sectors, and for impact resistance, obtaining materials with increasingly greater creep resistance capable of withstanding increasingly strong impacts and stresses). The materials treated with the radiant element according to the present invention will therefore be better from the point of view of the physical-mechanical characteristics, more reliable, durable over time and more resistant;
D. Ease of use: this is obtained, for example according to one version, with respect to combustion systems that require continuous maintenance and replacement of parts of the burners (such as heads, nozzles, recuperators, ceramic and consumable parts, etc.);
E. Computerization and standardization of the system: with radiant elements conceived in this way, both in terms of conformation and radiant mass/surface and internal heating elements, it is possible-through dedicated software systems-to input the amount of energy necessary to heat the element radiant by differentiating the heating zones as desired while maintaining the required temperature uniformity and leading to a significant reduction in the current or fuel needed to heat the radiant element itself. For example, when several means 10 are present, for example six electrical resistances or six fuel burners, it is possible to make them work intermittently or as needed, for example by activating the number 1, 3 and 5 keeping the resistance number 2, 4, 6 off, or lowering their power for subsequently repeat the same working operation on the contrary, i.e. increasing the power of the resistances number 2, 4 and 6 and lowering the other resistances number 1, 3, 5. The same can be obtained with heating means 10 of fuel burner type;
F. Energy efficiency and reduction/zeroing of harmful emissions: in addition to that which concerns the radiant element itself, also at the level of production of the electrical energy necessary for its operation, according to a specific embodiment of the invention. In fact, as previously mentioned, reducing consumption saves electricity or fuel and therefore reduces the emission of CO2 into the atmosphere with reference to production plants (electrical plants, nuclear plants and any other form of energy production);
G. Low power required for the heating means 10, for example electrically powered: thanks to the advantages set out above and the possibility of using several electrical resistances (3 or 6 or 9 or 12 or more, depending on the dimensions of the radiant element and the needs of heat treatment), each means 10 and/or each internal electrical resistance requires a power ranging from 10 Kw or from 17 Kw to 30 Kw up to 50 Kw or more if necessary. This also determines a reduction in electricity consumption, a greater possibility of control and the possibility of choosing the dimensions and shape of the resistances themselves, also allowing the radiant element to reduce its dimensions compared to traditional radiant tubes and, in the end, to being able to study new furnaces with smaller dimensions than the current ones;
H. Reduction of the stress exerted on the heating means: having the possibility of switching off or lowering the power of some means 10 and/or of some electrical resistances or combustion burners, there is no longer the need for continuous operation at 100% of their power, preserving the physical decay of the materials of which they are made and decreasing the need for their replacements, with a consequent reduction also in costs for users. Furthermore, the reduction of the necessary energy entails benefits for all the connected components such as the electrical substation which transforms the current to feed the resistances in the systems, the current passage cables which are less stressed and which can also be of smaller dimensions and finally, the consequent total management saving of the whole system;
I. Reduced risk of explosions and leaks: thanks to the low power required and reduced stresses;
J. Possibility of using renewable energy or energy obtained from renewable sources: for the production of electricity, it will be possible to use, in addition to the current power plants, photovoltaics, wind energy, nuclear energy, etc. The same goes for fuel, which can be from renewable sources, or neutral considering CO2 emissions, etc.

It can therefore be seen that the above-mentioned advantages cannot be obtained with the solutions known in the prior art.

The peculiarity of the radiant element according to the present invention consists in the fact that it distributes the energy emitted by the heating means 10 (that is to say by the electrical resistances according to at least one version of the present invention, or by the burners) through and on a surface (such as the wall 2) extremely wider than standard tubes, for example formed by individual tubes with a circular cross section.

According to the version in which the heating means 10 are electrically powered, in terms of mechanical characteristics, it is preferable that the resistances do not exceed 2.2-2.5 W/cm² and/or that they do not exceed 3.0-3.5 W/cm² considering the material of the radiant clement itself. The high powers required for the transfer of energy, i.e. of the heat from the radiant element to a metal sheet ribbon or other material for heat treatment, instead require greater powers and/or increasingly powerful resistances (from the classic 20 Kw up to 40 Kw and even at 60 Kw). This power cannot be tolerated in terms of mechanical characteristics and resistance to fatigue either by the resistors or even less by traditional tubes with a reduced surface area, such as that of a single tube with a circular section.

The radiant element according to the present invention, on the other hand, in at least one specific version, increases the radiating surface with respect to the standard solutions (also considering tubes with a diameter of 200 mm on the same pad) by more than 70%, thanks to the fact of mechanically “accept and support” the power given by the heating means 10 and to exchange it without stressing the base material of the radiant element itself. Furthermore, in addition to the improved results, the production costs are extremely competitive and lower than, for example, pipes marketed by the Kanthal company (which can reach thicknesses of up to 9 mm for a material composed of an iron, chromium and aluminium alloy, which however, at least above a certain threshold, it is less efficient in terms of heat exchange with respect to the present invention).

Furthermore, at least according to one version of the present invention, the radiant element, considering the overall system, can be defined as a sort of casing which contains the heating means 10, for example the electric resistances or fuel burners, in multiple and not single, as in a single radiant tube of a known type.

Finally, the radiant element according to the present invention is able to exchange a power equal to about 120 Kw or up to 240 Kw (respecting the parameters of W/cm² indicated above) produced by the heating means 10.

This power is required for each radiant element and thanks to the present invention it is possible to drastically reduce the mechanical and fatigue stress exerted on the material of the radiant element, thus leading not only to an active and effective transfer of heat towards the strip or the material to be treated but also to a longer life of the radiant element itself (compared, for example, to a circular section metal sheet tube).

The present invention also refers to a radiant system composed of the radiant element 1 and/or of a plurality of radiant elements 1 and of a relative number of heating means 10 and of their use in heat treatments.

The characteristics described for a version or embodiment or configuration of one of the components of the present invention may also be present in other variants or embodiments or configurations of one or more of the components of the present invention, without thereby departing from the scope protection afforded by the following claims.

1. A radiant element usable in at least one furnace for heat treatment, and/or for continuous galvanizing and annealing lines of sheet metal strips or plates and/or other products made of steel and/or other metals and/or for the modernization of at least one pre-existing furnace, wherein said radiant element is used to emit and/or radiate heat, wherein said radiant element has a main longitudinal extension (L) and a transversal extension (M), perpendicular to said main longitudinal extension (L), wherein said radiant element comprises a shaped wall which defines an external surface an internal surface and an internal cavity wherein said internal surface faces said internal cavity
and said external surface is opposite to said internal surface characterized in that said cavity comprises at least two main hollow seats
adapted in use to house at least one heating means and in that said radiant element also comprises at least one connection seat of said at least two main hollow seats.

2. The radiant element according to claim 1, wherein each of said at least two main hollow seats and said at least one connection seat have a main longitudinal extension parallel to each other and to said main longitudinal extension (L) of said radiant element.

3. The radiant element (1) according to claim 1, comprising n main hollow seats, with n greater than two, and n−1 connection seats or wherein said radiant element comprises three main hollow seats and two connection seats or six main hollow seats and five connection seats.

4. The radiant element according to claim 1, wherein said at least one main hollow seat has a cross section with a circular or polygonal shape, such as for example square, rectangular, prismatic, hexagonal, octagonal, etc., and/or a substantially cylindrical or parallelepiped shape, and/or wherein said at least one connection seat has a section transversal substantially polygonal, for example rectangular or square and/or a parallelepiped shape with a polygonal, rectangular or square base.

5. The radiant element according to claim 1, wherein said cavity is formed by said at least two main hollow seats and by said at least one connection seat which is therefore hollow.

6. The radiant element according to claim 5, wherein between said at least one main hollow seat and said at least one connection seat there is internally at least one port or opening for passage and/or connection of fluid between said at least two main hollow seats and said at least one connection seat.

7. The radiant element according to claim 1, wherein said wall is continuous and, at least as regards said main longitudinal extension (L) and said transversal extension (M), has no openings which can put said internal cavity in communication with the outside.

8. The radiant element according to claim 1, wherein said wall consists of at least two portions which delimit said at least one connection seat and at least one part which delimits each of said at least two main hollow seats.

9. The radiant element according to claim 8, wherein said at least two portions are substantially flat or curved and wherein said at least one part has a concavity facing the inside of said radiant element when said at least two main hollow seats are placed at the external and opposite longitudinal ends of said radiant element.

10. The radiant element according to claim 1, comprising two transverse ends placed on opposite sides of said main longitudinal extension (L), wherein said two transverse ends comprise a first end suitable in use to be connected and/or positioned at a first wall of the furnace, for example equipped with a “furnace side support” or “socket”, and a second end suitable in use to be connected and/or positioned at a second wall of the furnace, opposite said first wall, wherein said radiant element comprises a support for said radiant element placed at said first end and a containment element or pad placed at said second end.

11. The radiant element according to claim 1, wherein said radiant element comprises said at least one electric or fuel powered heating means and is able to heat said radiant element wherein said at least one heating means is housed in at least one or each of said at least two main hollow seats.

12. The radiant element according to claim 11, wherein said at least one electrically powered heating means comprises at least one electrical resistance or resistor and/or comprises a plurality of electrical longitudinal wires or electrical plates inside which electric current passes, wherein said plurality of electric longitudinal wires or electric plates is held in position and supported by at least one disc or by at least one plate made of a refractory material, such as for example a ceramic material or the like.

13. The radiant element according to claim 11, wherein said at least one fuel-powered heating means comprises at least one burner powered by said fuel such as for example gas, hydrogen, methane, biofuel, fuel with zero emissions, e-fuel, “carbon neutral” synthetic fuel, etc.

14. The radiant element according to claim 1, comprising at least one reinforcing means, for supporting and/or keeping said radiant element in position, preferably positioned inside said main hollow seat and/or inside of said at least one connection seat

15. The radiant element according to claim 14, wherein said reinforcing means comprises at least one plate a screw, a bolt, a rod, a pin, a peg, or other similar reinforcing elements, and/or has a cylindrical, conical, flat, parallelepiped, prismatic, etc. shape, and/or wherein said at least one reinforcing means is fixed, welded or pressure-fitted at said inner surface and/or of said external surface and/or of said at least one portion and/or of said part.

16. The radiant element according to claim 1, wherein said cavity said at least one main hollow seat and said at least one connection seat extend along the whole of said main longitudinal extension (L) of said radiant element.

17. The radiant element according to claim 1, comprising at least one of a shaped flange located at the second transverse end of said radiant element at least one compensator, reinforcing means and/or stiffening elements for example longitudinal, transversal and/or horizontal corrugations, bosses, ribs, grooves or the like, U-shaped elements, positioned or made at said internal surface and/or with said external surface.

18. A radiant system for at least one furnace for heat treatment, and/or for continuous galvanizing and annealing lines of sheet metal strips or plates and/or other products made of steel and/or other metals and/or for the modernization of at least a pre-existing furnace, comprising at least one radiant element according to claim 1 and at least one heating means or at least two heating means for heating up to 1200° C. or beyond said at least one radiant element and allow the latter in use to emit and/or radiate heat.

19. A method of using the radiant system according to claim 18, for carrying out a heat treatment of sheet metal strips or plates and/or other products made of steel and/or other metals in a heat treatment furnace, and/or for continuous lines of galvanization and annealing and/or for a modernized pre-existing furnace, wherein said at least one radiant element emits and/or radiates heat towards said sheet metal strips or plates and/or other products made of steel and/or in other metals in order to determine, for the same, a heat treatment.
